(19) United States
(12) Patent Application Publication
(10) Pub. No.: US 2015/0067571 A1
(43) Pub. Date: Mar. 5, 2015

(54) WORD PREDICTION ON AN ONSCREEN KEYBOARD

(71) Applicant: Randal J. Marsden, Edmonton (CA)

(72) Inventor: Randal J. Marsden, Edmonton (CA)

(21) Appl. No.: 14/046,836

(22) Filed: Oct. 4, 2013

Related U.S. Application Data
(60) Provisional application No. 61/709,929, filed on Oct. 4, 2012.

(51) Int. Cl. G06F 17/27; G06F 17/30; G06F 3/0488

(52) U.S. Cl. CPC G06F 17/276; G06F 3/0488; G06F 17/30542
USPC 715/773

(57) ABSTRACT

The present invention enables typing on a touchscreen without the need for the user to accurately hit each key on an onscreen keyboard. The relative distance and direction between each letter of a word on a virtual keyboard (visible or invisible) is used to uniquely identify the desired word by comparing parameters with those pre-stored in a word database. This means the user may begin typing at any location on the screen, without being constrained to a pre-determined location of an onscreen keyboard. It also means the size of the virtual onscreen keyboard may be determined by the user's typing pattern. Various disambiguation strategies can be applied to this typing approach to allow the user to be imprecise.

### BACKGROUND OF THE INVENTION

The origin of the modern keyboard as the primary method for inputting text and data from a human to a machine dates back to early typewriters in the 19th century. As computers were developed, it was a natural evolution to adapt the typewriter keyboard to be used as the primary method for inputting text and data. While the implementation of the keys on a typewriter and subsequently computer keyboards have evolved from mechanical to electrical and finally to electronic, the size, placement, and mechanical nature of the keys themselves have remained largely unchanged.

As computer operating systems evolved to include graphical user interfaces, the mouse pointer was introduced as a user input device that was complimentary to the keyboard. Various forms of pointing devices evolved from the original mouse, including trackballs and touchpads.

The paradigm of the keyboard and mouse was maintained for nearly three decades of computer evolution, as every desktop and laptop computer incorporated them in one form or another. However, recently, this paradigm has been shifting; with the introduction of touch surface computing devices (such as tablet computers), the physical keyboard and mouse are increasingly absent as part of the default user input modality. These devices rely solely on the user's touch interaction directly with the onscreen objects for input.

The concept of a keyboard, however, has not completely disappeared due to the fact that people still need to input large amounts of text data into the touchscreen device. Most touchscreen devices provide an onscreen keyboard that the user can type on. However, typing on the screen of a touch screen can be slow and lacks the tactile feel that allows the user to type quickly without looking at their fingers.

Some have attempted to solve the problem by building external keyboard solutions for the touchscreen devices, such as a case with a keyboard built into the flap. This approach, however, is a return to the laptop paradigm and negates many of the benefits introduced by a touchscreen-only approach.

In US Patent Application #2013/0021248 A1 filed on Jun. 22, 2012 by Eleftheriou et al., the inventors describe a system that allows an experienced user to type on a touch surface with no visual representation of the virtual keyboard needed (such as someone who is blind). This approach relies on polar coordinates of each selection point, referenced from an averaged center of all selection points entered by the user, and then compared to a database. Because these points can be arbitrarily anywhere on the screen, a special gesture is required to indicate the end of the word has been reached (a swiping motion left-to-right on the onscreen keyboard, for example). This approach suffers from the problem that this word-terminating gesture is not what most users are familiar with; they normally would just type a space with their thumb. However, the method taught by Eleftheriou would not be able to distinguish between a space selection and another key located, say, on the bottom row of the keyboard. Thus naturally typing is not achieved.

The present invention solves these problems by allowing the user to type on the touchscreen directly with all their fingers in a natural manner, but without looking.

### SUMMARY OF THE INVENTION

The present invention builds on U.S. patent application Ser. No. 12/234,053 (Marsden) which allows the user to rest their fingers on a touchscreen and distinguishes between fingers resting and fingers typing by employing both touch and vibration sensors.

In the present invention, the user rests their fingers anywhere on the surface of the touchscreen and begins typing by tapping their finger on a virtual key as they would on a regular keyboard (assuming, for example, a qwerty keyboard layout). The system detects the time and location of this tap and assigns it as the first letter of the desired word. The user then taps on the next virtual key, the system notes the time and location as the second letter of the word, and so on.

As the user proceeds with typing the word, the system determines the relative location of each key selection with those that preceded it, and compares those values with a pre-stored database containing the relative key positions for common words. By so doing, the system allows the user to define the “size” of the onscreen keyboard to be anything on which they can reliably distinguish key selection locations.

Even for short words, the relative key locations quickly become unique.

In a further embodiment of the invention, the system detects which finger is used for a given key selection (which is especially useful for 10-finger touch typists). The approach is helpful in disambiguating between words that might have very similar relative letter locations (such as “put”, “pit”, and “pot”). Because each of the vowels u, i, and o are typically typed with a different finger, it is possible to discern which letter was intended—even if the relative change from the first letter “p” is the same.

The space key, or other word ending punctuation, determines the end of the word.

In a preferred embodiment, most likely predicted words appear on the screen in a list next to the text insertion point or another convenient location. If the desired word appears in the list, the user may select it by simply tapping it. If the desired word is the default word in the list, the user may select it by tapping the return key on the onscreen keyboard.

The present invention may be combined with other disambiguation approaches commonly referred to as word prediction algorithms for even greater accuracy.

### BRIEF DESCRIPTION OF THE DRAWINGS

Preferred and alternative examples of the present invention are described in detail below with reference to the following drawings:

FIG. 1 illustrates a conventional layout of a virtual keyboard;

FIG. 2 illustrates an example of a perfectly aligned onscreen keyboard;

FIG. 3 illustrates an example of two handed separation such that a typist's right and left hands are positioned further from each other on a virtual keyboard than they would be on a mechanical keyboard;

FIG. 4 illustrates a circumstance opposite that shown in FIG. 3, with a typist's right and left hands set so closely together on a virtual keyboard as to cause a “negative” gap between the two halves of the keyboard;

FIG. 5 illustrates placement of a typist's hands such that keyboard halves are not aligned along the same x-axis;

FIG. 6 illustrates placement of a typist's hands in a way that defines a home row in which the keys are not aligned along the same linear vector;

FIG. 7 is a block diagram showing an exemplary system formed in accordance with an embodiment of the present invention;

FIGS. 8 through 13 show a flowchart of exemplary processes performed by the system shown in FIG. 7;

FIG. 14 is a schematic view a tablet device with a flat-surfaced virtual keyboard formed in accordance with an embodiment of the present invention; and

FIGS. 15 and 16 illustrate keyboard displays formed in accordance with embodiments of the present invention.

### DETAILED DESCRIPTION OF THE PREFERRED EMBODIMENT

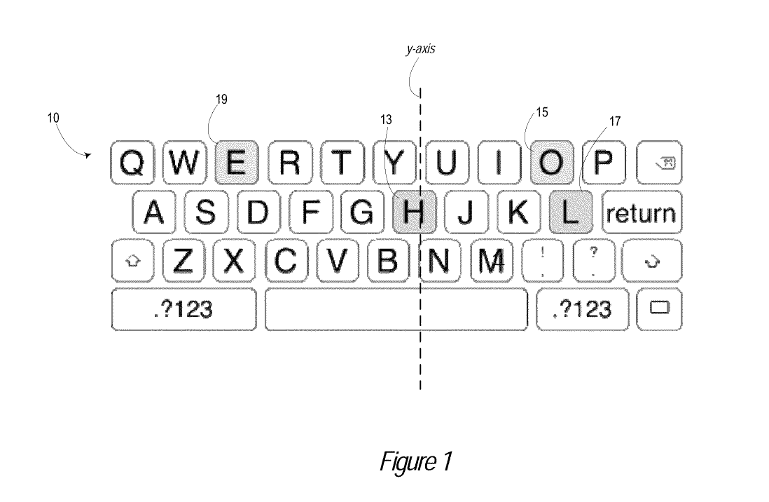

Before discussing instructions to a computer to perform specific tasks to disambiguate key actuation on a virtual keyboard, the explanation of the method is more comprehensible if explained in terms of the supporting rationale. As is shown in FIG. 1, the conventional keyboard is not laid out to strictly comport with a grid such that rows of letters are precisely above or below each other. By imposing a “y-axis,” it will be readily evident that there is no grid-like orientation of the keys. Rather, keyboards tend to be staggered. This fact makes the virtual keyboard 10 even more difficult to disambiguate because of the lack of tactile clues as to the location of keys 13, 15, 17, and 19. A method and a system of disambiguation must rely upon predictably placing these virtual keys suitably in order to determine what a user intends with each finger strike on the smooth surface of the virtual keyboard 10.

For example, when a user types the word “hello” as shown in FIG. 1, the reach for each key is distinct in assigned finger, direction and distance of displacement. Even in relative to alternating rows, the direction differs for each intended key strike. For example the “h” key 13, is not similarly displaced from the home row as the “o” key 15, the “l” key 17, or the “e” key 19.

What follows is an overview of several “special cases” used to develop the general method and system for performing disambiguation.

### Basic Word Pattern Algorithm (Perfectly Aligned Keyboard)

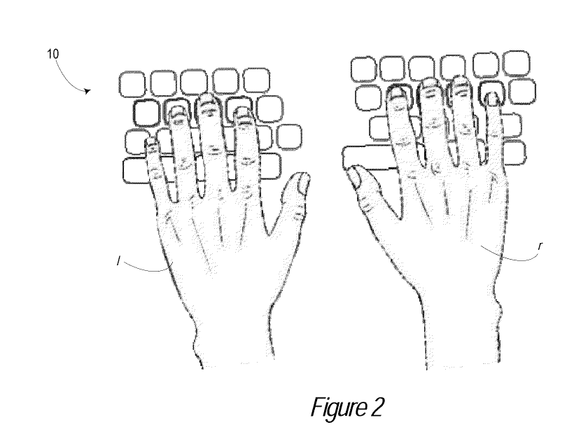

This first approach assumes a perfectly aligned onscreen keyboard, such as the one set forth in FIG. 2 hereto.

Step 1: A user determines the home row position, size, and orientation by setting down all eight fingers simultaneously (shown here as a right hand r and a left hand l). Distinct users will have distinct optimum home row position, size, and orientation and these are discernable from positioning of the fingers on the virtual keyboard. From this data, the system determines a constants, among them a home-row width (HRW)

HRW=Distance from the middle of the A key to the middle of the “;” key.

(This constant is needed to normalize the distances measured between keys, so-as to align with the database).

Step 2: The user, then, enters the first letter of a word. System stores x₁ and y₁ for location L₁ of the first letter.

Step 3: The user selects the next letter of a word. System stores x₂ and y₂ for location L₂ of the second letter.

Step 4: The system determines Δx_{1,2} and Δy_{1,2} to find the change in x and y locations between the first and second letters

Δx_{1,2}=x₁−x₂

Δy_{1,2}=y₁−y₂

Step 5: The system determines the absolute distance between L₁ and L₂.

d₁₂=√((x₁−x₂)²+(y₁−y₂)²))

Step 6: The system then develops a coefficient for each of the change in x and y directions as well as the absolute distance

ΔxN_{1,2}=Δx₁₂/HRW

ΔyN_{1,2}=Δy₁₂/HRW

ΔdN_{1,2}=Δd₁₂/HRW

Step 7: By comparing the normalized change in direction and absolute distance between the first two letters with those stored in the word database. The difference is calculated as an error E (Ex₁₂, for example, is the difference between the calculated normalized change in x and the pre-stored change in x between the first two letters). Select candidate words within a tolerance level T (where T is a user-settable variable).

Ex₁₂=ABS(ΔxN_{1,2}−Δx_{1,2} (stored for word n in the database))

Ey₁₂=ABS(ΔyN_{1,2}−Δy_{1,2} (stored for word n in the database))

T=ΣExₙ+ΣEyₙ

To amplify the difference between small misses and large misses, the square of the error can be used in calculations.

Step 8: Repeating steps 2 through 6 for each letter of the word, until a word-ending character is detected (space, period, etc.), the information gained generating better values as an iterative process.

Step 9: As a result, the system outputs the word that falls within the tolerance error level T. (If more than one word falls within the tolerance level, display them in a user selectable list, or output the word with the lowest tolerance error).

For additional accuracy, the segment length from letter to letter can be summed into a total distance for the entire word. This number can also be normalized and used to compare with the same in the word database.

So, d_{Total}=Σdistance between each letter=d_{1,2}+d_{2,3}+ . . . +d_{(n-1),n}

The normalized total word distance is:

dNₜₒₜₐₗ=d_{Total}/HRW

So, each word in the database would have at least the following data fields, and once populated, the system uses these values to refine the solutions:

| Data field | Description |
|---|---|
| ΔxN_{1,2} | The normalized change in x-direction |
| | between the first and second letter of the |
| | word. |
| ΔyN_{1,2} | The normalized change in y-direction |
| | between the first and second letter of the |
| | word. |
| . . . | . . . |
| ΔxN_{n-1,n} | The normalized change in x-direction for |
| | the last two letters of the word. |
| ΔyN_{n-1,nN} | The normalized change in y-direction for |
| | the last two letters of the word. |
| dN_{1,2} | The normalized distance between the first |
| | and second letters of the word. |
| . . . | . . . |
| dN_{n-1,n} | The normalized distance between the last |
| | two letters of the word |
| dN_{Total} | The normalized sum of all the distances |

### Two-Hand Separation Correction

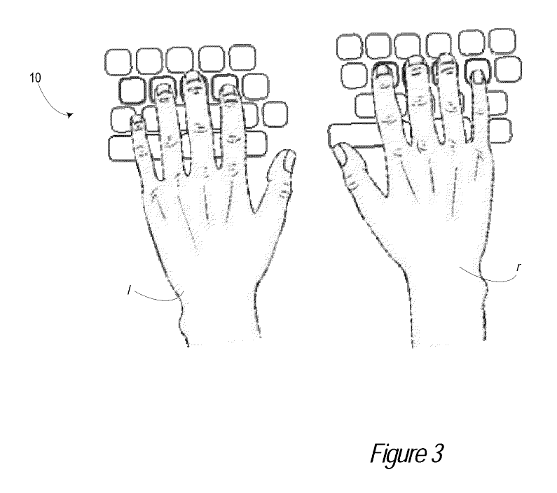

The above algorithm description assumes a straight, aligned onscreen keyboard. But what if the user sets down their hands apart and forms the keyboard with the left half separate from the right? In FIG. 3, the issue of two handed separation is depicted such that the right hand r and the left hand l are positioned further from each other than they would be on a mechanical keyboard.

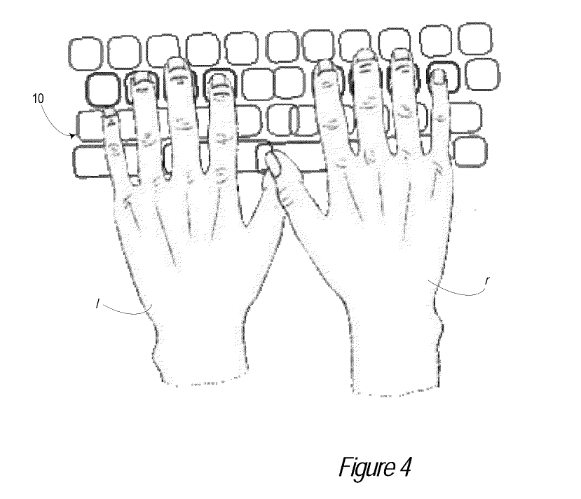

The opposite can also be true. In FIG. 4, the right hand r and the left hand l are such that the user has set them on the virtual keyboard 10 closer than on that same keyboard, causing a “negative” gap between the two halves of the keyboard.

To compensate for a shortened or lengthened keyboard, the system must determine the actual gap and then virtually compensate to a standard gap. To do this, the system must first determine what the distance between the “F” and “J” keys should be normally.

### Finding D(F˜J)

On a regular keyboard, the distance between F and J keys d(F˜J) is the same as d(A˜F) and d(J˜;). Since the system has already defined a home row width, the first step in determining d(F˜J) is to find d(A˜F) and d(J˜;) by measuring the number of pixels that are present between the centers of those keys. Then, the system will average these two distances and assign the result to d(F˜J):

d(F˜J)=(d(A˜F)+d(J˜;))/2

Next, the system measures the actual distance between the F and J keys based on the user's home-row definition.

dm(F˜J)=distance measured between the F and J keys

Now, the system determines the compensated adjustment from the gap between the F and J keys:

dc(F˜J)=compensated difference=d(F˜J)−dm(F˜J)

If the measured distance is less than the nominal distance (dm>d), then dc will be positive and indicates the amount that should be added to the x coordinate to right-hand keys to virtually adjust their location. (And vice versa if dm<d).

Once the left and right separation of each half of the keyboard has been virtually corrected, the regular algorithm can be used.

For this, the system will virtually align the x-axis for both halves. As a base, the system exploits the orientation of the screen of the device to use as a reference. Relative to that screen, the system rotates (virtually) each half to align with the true x-axis of the device.

Mathematically, the system will achieve this by calculating a vector from the middle of the “A” key to the middle of the “F” key and determine the angle of the vector as compared to the device's x-axis. In a similar manner, the system will determine an axis for the right hand side with a vector between the “J” and “;” keys.

Then, the system will determine the displacement necessary to rotate the left half as a group until it is aligned with the x-axis. Again, it will perform likewise for the right side.

### Non-Parallel Keyboard Halves

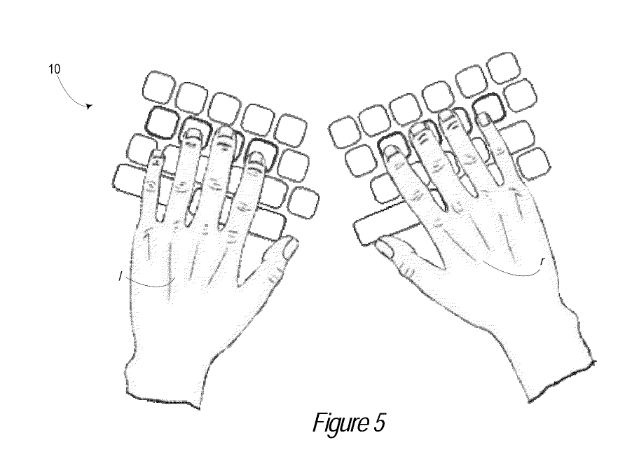

Next the system must correct for placement such that the keyboard halves are not aligned (at least approximately) along the same x-axis (e.g., as shown in FIG. 5). For this, the system must calculate the displacement necessary to virtually align the x-axis for both halves. Again, relying upon the orientation of the screen of the device as a reference, the calculations are such as to rotate (virtually) each keyboard half to align with the true x-axis of the device.

Again, the system relies upon a calculated vector from the middle of the “A” key to the middle of the “F” key and thereby determines the angle of the vector as compared to the device's x-axis. Do the same for the right hand side with a vector between the “J” and “;” keys. Then, the system mathematically rotates the left half as a group until it calculates the displacement necessary to align the keyboard half with the x-axis. Again, in a similar manner the system makes a calculation for the right side.

### Curved Home Row

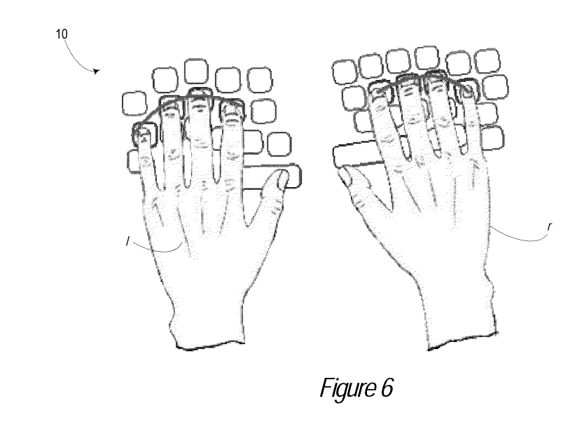

The last complication is depicted in FIG. 6 where the user defines a home row where the keys are not aligned along the same linear vector (which will almost always be the case). Again, the system must compensate by adjusting the keys to calculate the displacement necessary to line up along a straight line (separate for each half). (The simplest way is to generate a vector between the middle of the “A” key to the middle of the “F” key and then put the “S” and “D” keys along that vector. (And similarly for the right side). Note that other non-home row keys will also need to be adjusted, as they will be misaligned to follow their home row master.

Once the system has completed these calculations, it has a mathematical definition of the displacement necessary to rotate the halves to align with the device's x-axis (as in the previous section). Also as above, the system will adjust the gap between the halves to determine an appropriate displacement (as in the section titled “Two-hand Separation Correction”). Then, as above, the system must run the Word Pattern algorithm (see first section).

For 10-finger touch typists, each letter of the keyboard is assigned to a specific finger. The system can determine which finger was used to type a letter through the correlation of touch and vibration sensors. Thus, if a letter pattern is very similar for two or more words, the finger-assignment database can be invoked by the system to determine the most likely letter typed based on which finger was used. For example, the words “in” and “on” have very similar letter travel signatures, making them difficult for the system to disambiguate. However, at least for a touch typist, the letter “i” is typically typed with the right middle finger, while the letter “o” is typically typed using the right ring finger. Thus even though the values stored in the word database are similar for both words, the system can still tell which word the user meant to type.

### Directionality of Error

Errors encountered tend to be due to two issues: either because the user's hand is too far left, or too far right in relation to the virtual keyboard. These conditions increase the error on words with letters that alternate hands. This error will often be either a large positive value or a large negative error, depending on which hand is shifted and in which direction. The number should be either consistently positive or negative. If the user is inconsistent in the sign of this error, the reason usually means that such errors as are generated are less likely to be from a shifted hand, and more likely that this just isn't the word the user was trying to type. So for each change in sign of the error, a penalty is assessed to the total score.

### Double Letters

A common error when typing on a virtual keyboard is to either miss the second letter in a double-letter word, or accidentally get two letters of the same key when only one was intended. The present invention accounts for this ambiguity by comparing the input pattern with the most likely match(s) in the database and searching for double letters. If the pattern doesn't match, the mistaken key (either a false positive or a false negative) is ignored. This concept is extensible to any missing or extra letter, but at higher computational cost.

### Typing Styles

Studies have shown that roughly 30% of typists use nine or ten fingers (“touch typists”) and less than 5% use only two or three fingers. The remaining 65% are hybrid typists who use 4, 5, 6, 7, or 8 fingers. Models for each of these typing styles are stored in a database and the system constantly analyses the typing style of the user to determine what category of typist they are. Once identified, these models can be used to determine which finger is used for which key, and thus contributes to the disambiguation algorithms as described above.

There are many other mathematical operations that could be performed on the location data for each letter of a word that may further enhance the algorithm. What is described above is a simplified version intended for explanatory purposes, and the invention should not be considered to be restricted to only the algorithm described herein.

### “Hello” Example

As a simplified example, consider typing the word “hello” on the keyboard shown in FIG. 1. Consider the vertical lines as a course grid, along with each row of the keyboard. The user begins by typing the letter “h”, followed by a key that is 3.5 grid spaces to the left and one grid space up from h. The letter “l” follows “e” by the user selecting a key that is 6.5 grid spaces to the right and one grid space down, and so on. The database for the word “hello” would look like:

| Letter Pair | ΔX | ΔY |
|---|---|---|
| he | −3.5 | 1 |
| el | 6.5 | −1 |
| ll | 0 | 0 |
| lo | −0.5 | 1 |
| Total | 10.5 | 3 |
| Travel | | |

Even for a common 5-letter word such as hello, the travel pattern between keys is very unique. Very few words will have a similar pattern.

The database representation has been simplified for this example. In order to accommodate a variety of typing styles, the distance between letters wouldn't be fixed as shown in FIG. 1, and thus the need to normalize the travelled distances.

### User Typing Style Adaptation

As a user begins to type frequently, the system can begin to learn the user's typing style. For example, it can determine the approximate size of the onscreen keyboard and relative distances between keys specific to a certain user. In so doing, it can adapt by dynamically updating the word database to better match the user's typing style.

For example, referring again to FIG. 1, if a user types the word hello, but instead of moving −3.5 grid spaces horizontally between the h and e keys 13 and 19 respectively, the user might only move −3 grid spaces. After the word is completed, the system would see that there are no other matches for the word within the tolerance levels, other than the word “hello”, and so it could adapt its model so that now the distance between h and e stored in the database becomes −3.

### Storage of User Settings

This dynamic learning of the user's typing style can be stored both locally and in the “cloud” over a network. In this way, the same user may move from device to device (or touchscreen to touchscreen) and once the system identifies who the user its, it will load the settings and word databases specific to that user.

### Dynamic Topical Dictionaries

The word database itself can also change according to user identity. For example, a doctor may frequently use medical terms when writing, that wouldn't normally exist in a common-words database. The user can manually “load” topical dictionaries as part of their text entry settings, and/or the system can automatically detect when certain words are used and dynamically load the relevant dictionaries.

For example, a user may type the word “King”, which is identified in the common word dictionary as a medium frequency-of-use word. But in short succession, the user also types “Queen”, “Pawn”, and “Rook”. The system discerns that these words, while relatively uncommon in the main database, are very common in the Chess topical dictionary. It therefore begins to consider words in the Chess word database (mixed with words from the main database) with a higher probability as a result.

Topical dictionaries can be stored in the cloud, and this dynamic adaptation to the user may happen at any location and on any device where the user is uniquely identified. Thus in a future that has fewer personal devices, but a more ubiquitous computing environment where interfaces to information are embedded into the physical world around us, an individual's typing settings can follow with them.

### Next-Next Word Prediction Using Conjunctions and Articles

A common strategy in word prediction is to store associations between words, called “next-word prediction”. For example, if your name were John Smith, then Smith would be a very common next-word to follow John. These relationships can be stored in a reasonably sized database and used to help disambiguate typing as described herein.

However, next-word prediction fails with certain very common words. For example, consider the word “the” (most commonly used word in the English language). Let's say a user typed “kick the”. Suddenly, nearly every noun, adverb, and adjective become potential next-word candidates for the word “the”, losing all the context of “kick”. In this case, the next-word prediction provides virtually no help in disambiguating typing.

If the system were to store next-next-word relationships for all the words in the database, it would quickly become unwieldy; simply too many word relationships would exist (the majority of which would never occur). Instead, we recognize that there are a relatively few number of words that have a large number of likely next-words associated with them. These words are labeled as conjunctions and articles in English. The table below shows common conjunctions and articles.

| Part of Speech | Example words |
|---|---|
| Conjunctions | And, but, for, or, nor, yet, and so |
| Articles | A, an, the |

Next-Next-word relationships are stored in the database for only these words, by joining them with the word that preceded them. For example, “kick the” would become a new word in the database stored as “kickthe”. Now the new word entity kickthe has a relatively few common next words, such as ball, bucket, and habit. Thus the context of “kick” is preserved.

This type of next-next-word prediction can be very helpful in disambiguating typing according to the method described in the present invention.

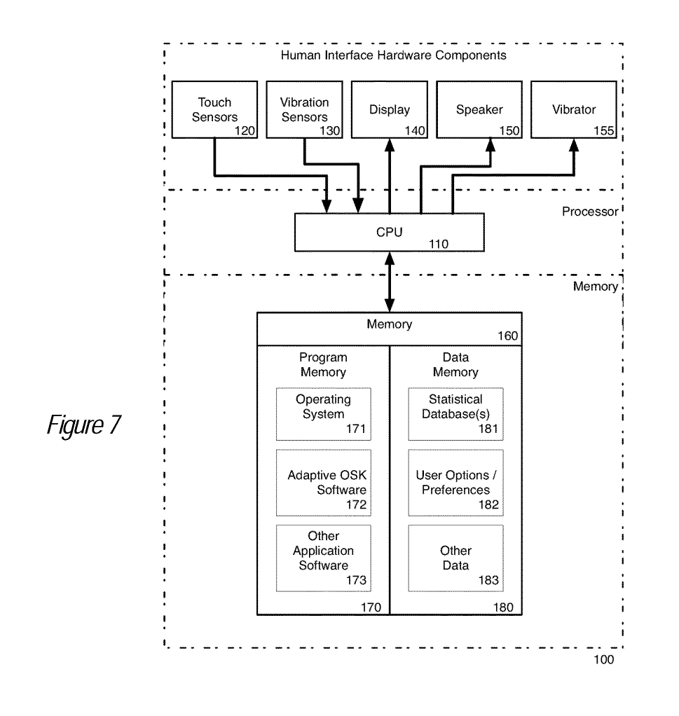

FIG. 7 shows a block diagram of an exemplary device 100 for providing an adaptive onscreen keyboard user interface for alphanumeric input. The device 100 includes one or more touch sensors 120 that provide input to a CPU (processor) 110. The touch sensors 120 notify the processor 110 of contact events when a surface is touched. In one embodiment, the touch sensor(s) 120, or the processor 110, include a hardware controller that interprets raw signals produced by the touch sensor(s) 120 and communicates the information to the processor 110, using a known communication protocol via an available data port. The device 100 includes one or more vibration sensors 130 that communicate signals to the processor 110 when the surface is tapped, in a manner similar to that of the touch sensor(s) 120. The processor 110 generates a keyboard image that is presented on a display 140 (touch surface) based on the signals received from the sensors 120, 130. A speaker 150 is also coupled to the processor 110 so that any appropriate auditory signals are passed on to the user as guidance (e.g., error signals). A vibrator 155 is also coupled to the processor 110 to provide appropriate haptic feedback to the user (e.g., error signals). The processor 110 is in data communication with a memory 160, which includes a combination of temporary and/or permanent storage, and both read-only and writable memory (random access memory or RAM), read-only memory (ROM), writable nonvolatile memory, such as FLASH memory, hard drives, floppy disks, and so forth. The memory 160 includes program memory 170 that includes all programs and software such as an operating system 171, adaptive onscreen keyboard (“OSK”) software component 172, and any other application programs 173. The memory 160 also includes data memory 180 that includes a word database(s) 181, a record of user options and preferences 182, and any other data 183 required by any element of the device 100.

Once a home-row event has been detected by the processor 110 based on signals from the sensors 120, 130, the processor 110 positions a virtual on-screen keyboard beneath the user's fingers on the display 140. As the user types, the processor 110 constantly monitors the placement of the user's fingers, as well as tapped locations for each key actuation, and makes adjustments to the location, orientation, and size of each key (and the overall keyboard) to ensure the on-screen keyboard is located where the user is typing. In this way, it is possible to account for the user's “drifting”, or moving their fingers off of the original position of the on-screen keyboard. If the user drifts too far in one direction so-as to reach the edge of the touch sensor area, the processor 110 outputs an audible and/or haptic warning.

At any time, the user may manually re-assign the location of the on-screen keyboard by initiating a home-row definition event (as described above).

In one embodiment, haptic feedback is provided via the vibrator 155 when the user positions their index fingers on the keys commonly-referred to as the “home keys” (F and J keys on a typical English keyboard). In one embodiment, a momentary vibration is issued when the user rests their fingers on the keys using a slightly different frequency of vibration for left and for right. In this manner, the user may choose to move their hands back into a fixed home-row position, when the user chooses the processor 110 to not dynamically change the position of the on-screen keyboard. In another embodiment, the intensity of these vibrations may change depending upon finger position relative to the home keys of the fixed home-row.

The device 100 allows the user to type without looking at their fingers or the virtual keyboard. It follows, then, that the keyboard need not be visible at all times. This allows valuable screen space to be used for other purposes.

In one embodiment, the visual appearance of the keyboard varies its state between one or more of the following: visible, partially visible, invisible, and semitransparent. The full keyboard visually appears when a home-row definition event takes place or when the user has rested their fingers without typing for a settable threshold amount of time. As the user begins to type, the keyboard fades away to invisible until the user performs any one of a number of actions including, but not limited to: a home-row definition event, pausing typing, pressing on four fingers simultaneously, or some other uniquely identifying gesture. In another embodiment, the keyboard does not fade away to be completely invisible, but rather becomes semitransparent so the user can still discern where the keys are, but can also see content of the screen that is “beneath” the on-screen keyboard.

In one embodiment, the keyboard temporarily “lights”, or makes visible, the tapped key as well as those that immediately surround the tapped key in a semitransparent manner that is proportional to the distance from the tapped key. This illuminates the tapped region of the keyboard for a short period of time.

In one embodiment, the keyboard becomes “partially” visible with the keys having the highest probability of being selected next lighting up in proportion to that probability. As soon as the user taps on a key, other keys that are likely to follow become visible or semivisible. Keys that are more likely to be selected are more visible, and vice versa. In this way, the keyboard “lights” the way for the user to the most likely next key(s).

In one embodiment, the onscreen keyboard is made temporarily visible by the user performing tap gestures (such as a double- or triple-tap in quick succession) on the outer rim of the enclosure surrounding the touch-sensitive surface.

The various modes of visual representation of the on-screen keyboard may be selected by the user via a preference setting in a user interface program.

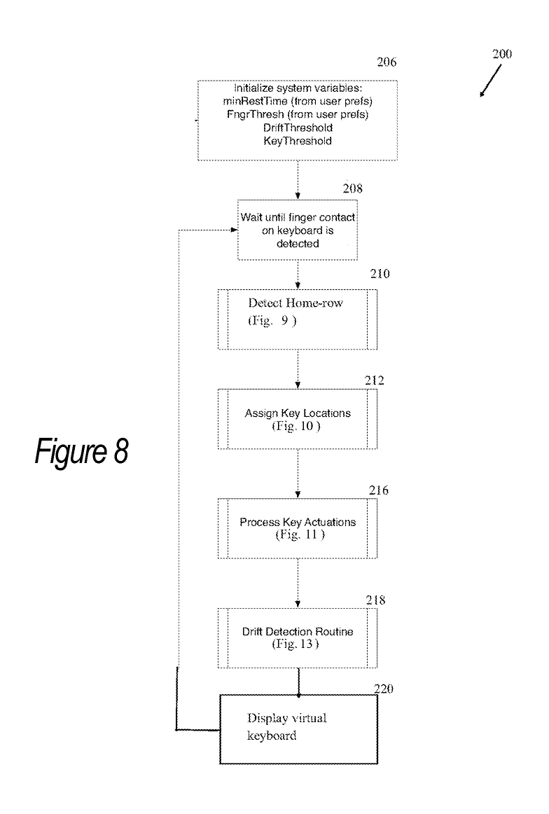

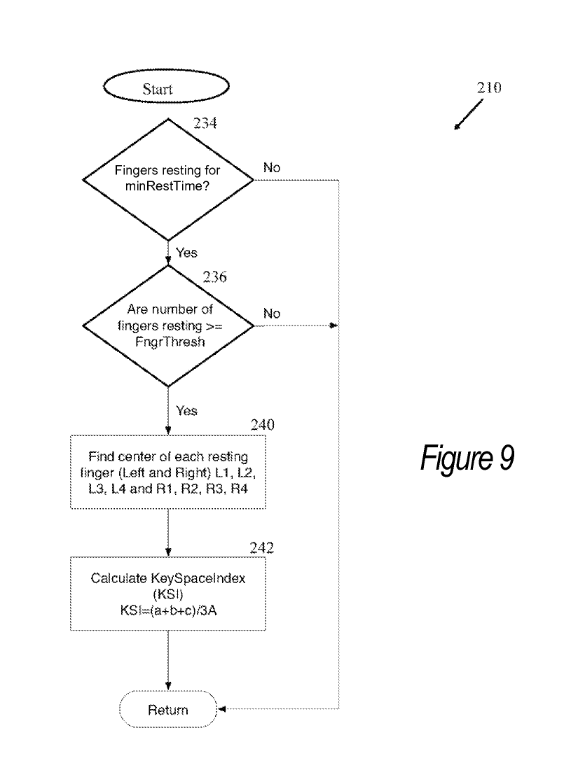

FIGS. 8-13 show an exemplary process performed by the device 100. The flowcharts shown in FIGS. 8-13 are not intended to fully detail the software of the present invention in its entirety, but are used for illustrative purposes.

FIG. 8 shows a process 200 executed by the processor 100 based on instructions provided by the OSK software component 172. At block 206, when the process 200 is first started, various system variables are initialized, such as minimum rest time, number of finger touch threshold, drift distance threshold and key threshold. At block 208, the process 200 waits to be notified that a contact has occurred within the area of a touch-screen. Then, at block 210, home-row detection occurs based on signals from one or more of the sensors 120, 130. Home-row detection is described in more detail in FIG. 2B. At a block 212, locations of keys for the to-be-displayed virtual keyboard are determined based on the sensor signals. The key location determination is described in more detail in FIG. 2C. Next, at block 216, key activations are processed (see FIGS. 2D and E for more detail.) At a block 218, user's finger drift is detected based on the sensor signals. Finger drift is described in more detail in FIG. 2F. Then, at block 220, a virtual keyboard is presented on the display 140 based on at least one of the determinations made at blocks 210-218. The process 200 repeats when a user removes their eight fingers and then makes contact with the touchscreen.

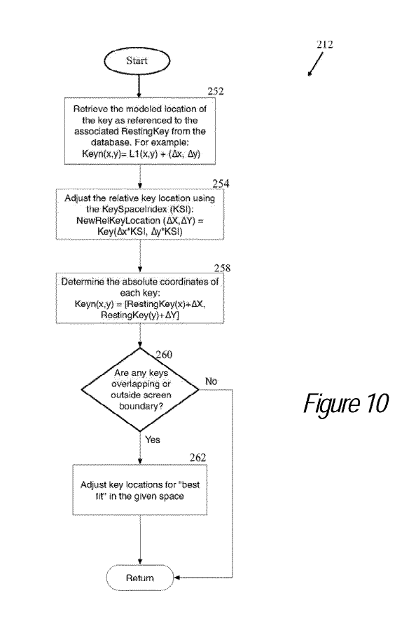

FIG. 10 shows the home-row detection process 210. At a decision block 234, the process 210 determines if a user has rested their fingers on the touch-screen for a minimum amount of time (i.e., minimum rest threshold). At a decision block 236, the process 210 determines if the appropriate number of fingers have rested on the touch surface, thus initiating a home-row definition event. If the conditions in either blocks 234 or 236 are not met, the process 210 exits without changing the location of the on-screen keyboard.

Once both the time and number of resting fingers requirements are met, the processor 110 determines the location of the resting fingers, see block 240. A KeySpaceIndex (or “KSI”) value is then determined in block 242. The KSI is used to customize the on-screen keyboard to the size and spacing of the user's fingers.

The KSI may change from one home-row definition event to the next, even for the same user. In one embodiment, all four fingers of each hand are resting on the touch surface to initiate the home-row definition event. In such a case, the KSI is given by the following formula:

KSI=(Average RestingKey Spacing)/(Modeled Nominal Spacing)=[(a+b+c)/3]/A=(a+b+c)/3A

where,
A=a modeled nominal distance between keys (typically 19 mm)
a=the measured distance between RestingKey1 and RestingKey2
b=distance between RestingKey2 and RestingKey3
c=distance between RestingKey3 and RestingKey4.

The KSI formula can be adjusted accordingly if fewer than four resting fingers are used to initiate a home-row definition event (as defined in a set of user preferences stored in a database). The KSI is used in subsequent processes.

A data model for a standard onscreen keyboard is stored in memory of the system. In this data model, the onscreen keyboard layout is divided into two sections: keys normally typed with the right hand, and keys normally typed with the left hand. Further, each key is related to the home-row resting key that is rested upon by the finger that is most likely to type that particular key (defined as the “related resting key”). The location of each key is defined in the data model as a relative measurement from its related resting key.

An exemplary formula for determining the location of each key is given as:

Key(x′,y′)=KeyModel (x*KSI,y*KSI)

Where,
x=the nominal stored x distance from the center of the Related Resting Key (RRK)
y=the nominal stored y distance from the center of the RRK

It is possible that the modified key positions of two or more keys may overlap. If that is the case, the size of the overlapping keys is reduced until the overlap is eliminated.

The orientation of the X-Y axis is determined separately for each resting key. For each of the left and right sectors, a curve is fit to the resting keys in that sector. The X-Y axis for each key is then oriented to be the tangent (for the x-axis) and orthogonal-tangent (for the y-axis) to the curve at the center of that key.

FIG. 10 shows the assigning key locations process 212. The process 212 is repeated for each key of the keyboard. At block 252, a prestored location for each key is retrieved from the database 181, relative to its associated resting key position in the form [RestingKey, Δx, Δy]. For example, the key representing the letter “R” is associated with the resting key L1 (typically the letter “F”), and is positioned up and to the left of L1. Thus, its data set would be [L1, −5, 19] (as measured in millimeters). Similar data is retrieved for each key from the database 181. At block 254, a new relative offset is calculated for each key by multiplying the offset retrieved from the database by the KSI. At block 258, the absolute coordinates of each key is then determined by adding the new offset to the absolute location of the associated resting key as determined at block 254. At decision block 260, the process 212 tests to see if any keys are overlapping, and if so, their size and location are adjusted at block 262 to eliminate any overlap. Then the process 212 returns to the process 200.

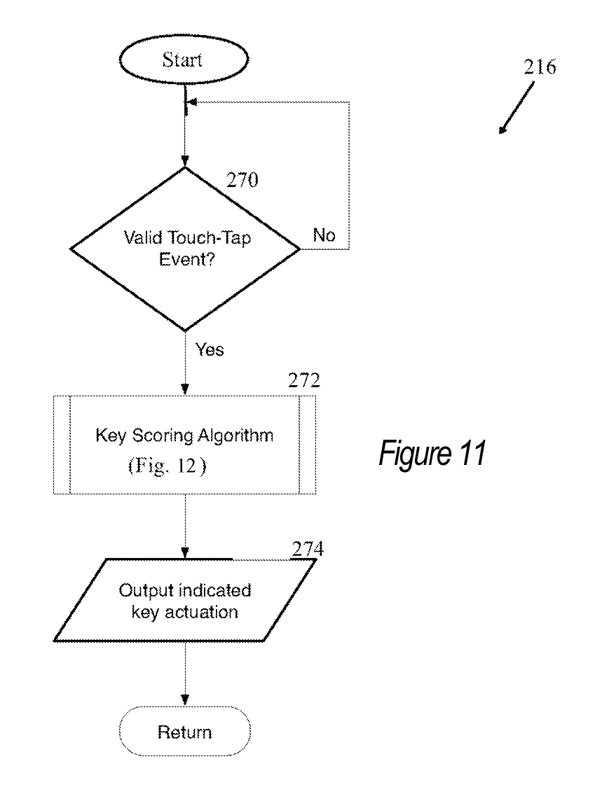

FIG. 11 shows the process-key actuations process 216, whereby the actual key events are determined and output. The process 216 begins at decision block 270 that tests if a valid touch-tap event has occurred. This is determined through a correlation between the touch sensor(s) 120 and vibration sensor(s) 130 as explained more fully in Marsden et al., U.S. Patent Application Serial No. 2009/0073128. Candidate keys are scored by applying a key scoring algorithm at block 272. The key with the highest score is then output at block 274 and the process 216 returns.

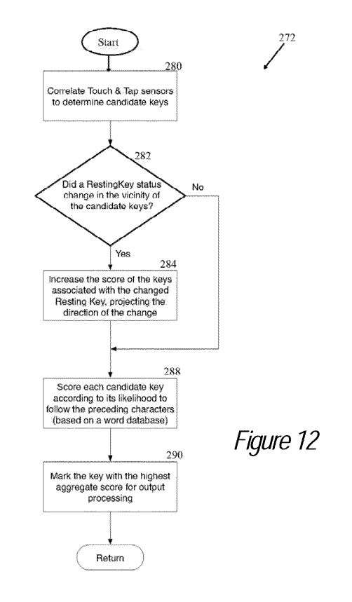

FIG. 12 shows a process for the key scoring algorithm from block 272 of FIG. 11. At block 280, signals received by the touch sensors 120 and the vibration sensors 130 are correlated to determine where the user's tap took place and the system defines keys in the immediate vicinity as “candidate keys”. By considering keys surrounding the area of the tap (rather than just the key where the tap took place), the processor 110 accounts for ambiguity in the user's typing style. At a decision block 282, the process 272 tests to see if the user moved their finger from a resting key to type. Note that in typical typing styles, even a 10-finger touch typist will not constantly rest all four fingers at all times. So, it isn't a prerequisite that a change in a resting key take place in order for a valid key to be typed on. However, if a change does take place to the state of a resting key in the vicinity of the candidate keys (or if it is a candidate key itself), useful information can be obtained from such change as explained at block 284.

At block 284 a virtual line is calculated between the resting key in the vicinity of the tap for which a state change was detected, and the location of the tap, as calculated at block 280. The virtual line extends beyond the tap location. At block 284 keys that the projected line passes through or by are determined and the processor 110 increases the score of those keys accordingly. In this way, relative movements in the direction of the desired key are correlated to that key, even if the tap location doesn't occur directly on the key. At block 288, the processor 110 takes into account the preceding words and characters that were typed as compared with linguistic data stored in data memory 181. This includes commonly known disambiguation methods such as: letter-pair statistical frequencies, partial-match prediction, inter-word prediction, and intra-word prediction. Appropriate scoring is assigned to each candidate key.

At block 290, the candidate key with the highest score representing the highest calculated probability of the user's intended selection is determined and the process 272 returns.

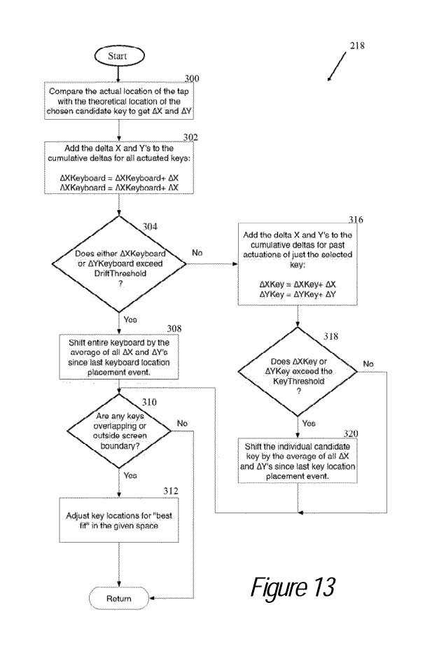

FIG. 13 shows the drift detection process 218 for accommodating when the user inadvertently moves their hands (or “drifting”) as they type. The process 218, at block 300, compares the actual tap location with the current center of the displayed intended key, and stores the difference in the X and Y coordinates as ΔX and ΔY. These differences are added to a previous cumulative total from previous keystrokes at block 302. At decision block 304, the processor 110 tests if the cumulative difference in either direction exceeds a prestored variable called “DriftThreshold” (as defined from user preference or default data stored in data memory 182). If the threshold is exceeded, the processor 110 moves the location of the entire keyboard in block 308 by the average of all ΔXs and ΔYs since the last location definition event. If the cumulative differences do not exceed the DriftThreshold for the entire keyboard, then a similar calculation for the individual selected key is performed at block 316. At decision block 318, the processor 110 tests if the cumulative differences for that individual key exceeds the user-defined key threshold after block 316 and, if so, adjusts its location at block 320. The key threshold is the permissible amount of error in the location of the tap as compared to the current location of the associated key. When key threshold has been exceeded, the associated key will be moved. After block 308, if the decision at block 318 is No, or after block 320, then at block 310, the processor 110 tests if any of the new positions overlap with any other keys and if the overall keyboard is still within the boundaries of the touch sensors. If there are any conflicts for either test, they are corrected with a “best fit” algorithm in block 312 and then exits. Also, if no conflicts are found, the process 218 returns.

Even though the method of the present invention will allow the user to type without the onscreen keyboard being visible, there are still times when a user will want to view the keys. For example, if they don't know which key is associated with a desired character, or where certain characters are located on a separate numeric and/or symbols layer. Other users may not be able to type from rote, knowing by memory where each character is located. For these, and other reasons, it is important to visually present the onscreen keyboard on the screen of the device.

According to stored user's preference, the onscreen keyboard can remain visible continuously while typing is taking place. Alternatively, the onscreen keyboard becomes transparent after the home-row definition event. In one embodiment, the onscreen keyboard becomes semitransparent so-as to allow the user to see through the keyboard to content on the screen below.

In the case where the keyboard is set to be invisible, other content may be displayed on the full screen. There may be other user interface elements, such as buttons, that will appear to be active yet be located below the invisible onscreen keyboard. In such a case, the device 100 intercepts the user's input directed toward such an element and causes the onscreen keyboard to become visible, reminding the user that it is indeed present. The user may then elect to “put away” the keyboard by pressing a corresponding key on the keyboard. Note that putting away the keyboard is not the same as making it invisible. Putting away the keyboard means to “minimize” it off the screen altogether, as is a common practice on touchscreen devices.

In one embodiment, the onscreen keyboard cycles between visible and invisible as the user types. Each time the user taps on the “hidden” onscreen keyboard, the onscreen keyboard temporarily appears and then fades away after a user-settable amount of time.

In one embodiment, only certain keys become visible after each keystroke. The keys that become temporarily visible are those keys that are most likely to follow the immediately preceding text input sequence (as determined based on word and letter databases stored in the system).

In one embodiment, the onscreen keyboard becomes temporarily visible when the user, with fingers resting in the home-row position, presses down on the surface with their resting fingers based on changes sensed by the touch sensors 120.

In one embodiment, the onscreen keyboard becomes visible when the user performs a predefined action on the edge of the enclosure outside of the touch sensor area, such as a double- or triple-tap.

The onscreen keyboard, if set to appear, will typically do so when a text-insertion condition exists (as indicated by the operating system 171), commonly represented visually by an insertion carat (or similar indicator).

In one embodiment, the tactile markers commonly used on the F and J home-row keys are simulated by providing haptic feedback (such as a vibration induced on the touchscreen) when the user positions their fingers to rest on those keys. In this way, the user may choose for the keyboard to remain stationary in the same onscreen position, yet find the correct placement of their hands by touch only (without looking).

To increase the accuracy of the keyboard, statistical models of language are used. If a touch/tap event yields an ambiguous key choice, the statistical models are called upon by the processor 110 to offer the key that is most likely what the user intended.

This “disambiguation” is different from other methods used for other text input systems because in the present invention a permanent decision about the desired key must be made on the fly. There is no end-of-word delineation from which word choices can be displayed to the user and the output modified. Instead, each time the user taps on a key, a decision must be made and a key actuation must be sent to a target application program (i.e., text entry program).

Several statistical analysis methods can be employed: partial-match letter prediction, current-word prediction, next-word prediction, and conjunctive next-word prediction. These are explained in detail in the following sections.

### Prediction by Partial Match

A well-known algorithm originally invented for data compression useful in this case is prediction by partial match (or PPM). Applied to a keyboard, the PPM algorithm is used to predict the most likely next character, given a string of characters that has already occurred (of length k). Computing time and resources grow exponential with the value of k. Therefore, it is best to use the lowest value of k that still yields acceptable disambiguation results.

By way of example, let k=2. A process of the present invention looks back at the past two characters that have been entered and then compare probabilities from a database of the most likely next character(s) to be typed. For example, the underlined letters below show what is used to predict the next most likely letter:

An

An_{—}

An e

An ex

An exa

An exam

An examp

An exampl

An example

The data storage required for this algorithm for a total number of possible keys A is:

A^{k+1}

For a typical onscreen keyboard, this process consumes less than 1 MB of data.

The statistical model is built up for each language (although with a small value for k); the table may be similar for languages with common roots. The model also dynamically updates as the user enters text. In this way, the system learns the users typing patterns and more accurately predicts them as time goes on.

Language variants are provided in the form of language-specific dictionaries configured through an operating system control panel. The control panel identifies the current user's language from the system locale and selects the appropriate prediction dictionary. The dictionary is queried using a continuously running “systray” application that also provides new word identification and common word usage scoring.

In one embodiment, a database made up of commonly used words in a language is used to disambiguate intended key actuations. The algorithm simply compares the letters typed thus far with a word database, and then predicts the most likely next letter based on matches in the database.

For example, say the user has typed “Hel”. Possible matches in the word database are:

Hello (50)

Help (20)

Hell (15)

Helicopter (10)

Hellacious (5)

The numbers beside each word represent their “frequency” of use, normalized to 100. (For convenience sake, the total frequencies in this example add up to 100; but that would not normally be the case).

The candidate letters that most likely follow “Hel” are:

L (70)—probabilities added for the words “Hello”, “Hell”, and “Hellacious”

P (20)

I (20)

This example is particularly useful, in that the letters L, P, and I are all in close proximity to one another. It is possible, and even likely, that the user may tap on a location that is ambiguously near several keys (I, O, P, or L, for example). By adding word prediction, the choice is significantly disambiguated; in this example, the obvious most-likely next letter is “L”.

Note that this implementation of the word prediction algorithm is different from that traditionally used for onscreen keyboards, because it is not truly a word prediction system at all: it is a letter prediction system that uses a word database.

In one embodiment, word pairs are used to further disambiguate the most likely selected key. With simple word prediction, there is no context to disambiguate the first letter of the current word; it is completely ambiguous. (This disambiguation is reduced slightly for the second letter of the word, and so on for the remainder of the word.) The ambiguous nature of the first few letters of a word can be significantly reduced by taking into account the word that was entered immediately previous to the current word; this is called “next-word prediction”.

For example, if the word just typed was “Cleankeys”, common next words stored in the database may be:

Keyboard (80)

Inc. (20)

Is (20)

Will (15)

Makes (10)

Touch (5)

If the user ambiguously taps between the I and K keys for the start of the next word, the next-word prediction algorithm can help disambiguate (in this case, “K” would win).

Logic may dictate that the concept of considering the previous word typed could be carried to the previous k words typed. For example, for k=2, the system could store a database that has 2nd-degree next-words (or next-next-words) for every word in the database. In other words, look back at the two previous words in combination to determine the most likely word to follow. However, this quickly becomes unwieldy, both in terms of space and computing power. It simply isn't practical to store that many combinations, nor is it very useful, because most of those combinations would never occur.

There is, however, a significant exception that is worth considering: words that have a very large number of next-word candidates. Such is the case for parts of speech known as conjunctions and articles.

The seven most-used conjunctions in the English language are:

and, but, or, for, yet, so, nor.

The articles in the English language are:

the, a, an.

By special-casing these 10 words, the system improves first-letter predictions.

Consider the phrase: kick the_{—}

Because every noun in the database is most likely a next-word candidate for the article “the”, there is very little use derived from the next-word prediction algorithm. However, if the context of “kick” before the article “the” is retained, a much richer next-next-word choice is attained. Effectively, a new “word” is stored in the database called “kick_the”. This new entity has the following next-word candidates:

Ball (50)

Bucket (20)

Habit (15)

Can (10)

Tires (5)

Thus one can confidently predict that the most likely next letter to follow the phrase “kick_the_” is the letter “B”.

Any word that is found combined with a conjunction or article is combined with those parts of speech to form a new word entity.

A notable difference between the letter-by-letter prediction system described herein and a word-based prediction system is the ability to dynamically reorient the prediction for each letter. For example, if a guess is wrong for a specific key and the desired word subsequently becomes clear, the algorithm abandons the choice it made for the incorrect letter and applies predictions for the remaining letters, based on the newly determined target word.

For example:

| | Ambiguous | | |
|---|---|---|---|
| Text Entered | Candidate Keys | Predicted Words | Predicted Letter |
| Kick_the | B, h, g | Ball, bucket, habit, | B |
| | | goat, garage | |
| Kick the b | A, q, s | Ball, habit, garage | A |
| Kick the ba | B, v, space | habit | B |
| Kick the bab | I, k, o | habit | I |
| Kick the babi | T, r | habit | T |
| Kick the babit | Space, n, m | habit | space |

As the word progresses, it is shown that the initial letter “B” should have been an “H” (these letters are near one another on the qwerty keyboard layout and one could easily be mistaken for the other). But rather than commit completely to that first letter, and only consider words that start with “B”, other candidates are still considered by the system in predicting the second letter. So, B, H, and G are considered as the first letter for subsequent keys. In this way, the mistake isn't propagated and the user would need to only make one correction instead of potentially many.

So, for each new key entered, keys that are adjacent it as well as other ambiguous candidates are considered as possibilities in determining subsequent letters.

When a mistake is made and the user backspaces and corrects it, the system can feed that data back into the algorithm and make adjustments accordingly.

For example, the user ambiguously enters a key in the middle of the keyboard and the scoring algorithm indicates that potential candidates are “H”, “J”, and “N”; the scores for those three letter fall into the acceptable range and the best score is taken. In this example, let's say the algorithm returns the letter “J” as the most likely candidate and so that is what the keyboard outputs. Immediately following this, the user unambiguously types a <backspace> and then an “H”, thus correcting the error.

This information is fed back into the scoring algorithm, which looks at which subalgorithms scored an “H” higher than “J” when the ambiguous key was originally entered. The weighting for those algorithms is increased so if the same ambiguous input were to happen again, the letter “H” would be chosen. In this way, a feedback loop is provided based directly on user corrections.

Of course, the user can make typing mistakes themselves that are not the result of the algorithm; it correctly output what the user typed. So, care must be taken when determining if the user correction feedback loop should be initiated. It typically occurs only when the key in question was ambiguous.

A user-settable option could allow the keyboard to issue backspaces and new letters to correct a word that was obviously wrong. In the example above, once the predictor determines that the only logical word choice is “habit”, the keyboard would issue backspaces, change the “b” to an “h”, reissue the subsequent letters (and possibly even complete the word).

With so many factors lending to the disambiguation of a key, all algorithms can potentially add to the candidacy of a key. This approach is called scoring; all algorithms are weighted and then added together. The weighting is dynamically changed, to tune the scoring algorithm to the user's typing style and environment.

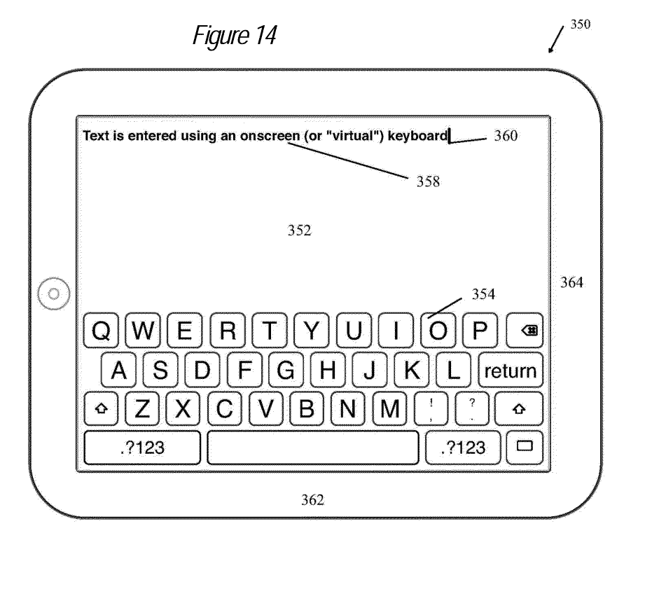

FIG. 14 shows a view representative of a typical handheld tablet computer 350 that incorporates on its forward-facing surface a touch-sensitive display 352 and a keyboard 354 designed and used in accordance with an embodiment of the present invention. The keyboard 354, when used in accordance with the present invention, generates text that is output to the text display region 358 at a text insertion location 360. The term “keyboard” in this application refers to any keyboard that is implemented on a touch- and tap-sensitive surface, including a keyboard presented on a touch-sensitive display. The keyboard 354 shows the letters of the alphabet of the respective language selected by the user on individual keys, arranged in approximately the standard “QWERTY” arrangement found on most keyboards.

In one embodiment, the orientation, location, and size of the keyboard (as well as individual keys) are adaptively changed according to the input behavior of the user. When the user rests their fingers on the touch surface 352 in a certain way, the system moves the keyboard 354 to the location determined by the resting fingers. When the user intends to actuate a key on the keyboard 354, they “tap” on the desired key by lifting their finger and striking the surface 352 with discernable force. User taps that occur on areas 362, 364 outside of the touch sensor area 352 are detected by the vibration sensor(s) and may also be assigned to keyboard functions, such as the space bar.

The absence of a touch sensor signal is in effect, a signal with a value of zero, and when correlated with a tap (or vibration) sensor can be used to uniquely identify a tap location. In one embodiment, the vibration signal for specific regions outside of the touch sensor area 352, such as those indicated at areas 362, 364, are unique and stored in a database by the system. When the absence of a touch signal occurs in conjunction with a tap event, the system compares the vibration characteristics of the tap with those stored in the database to determine the location of the external tap. In one embodiment, the lower outer boundary area 362 is assigned to a space function, while the right outer boundary area 364 is assigned to a backspace function.

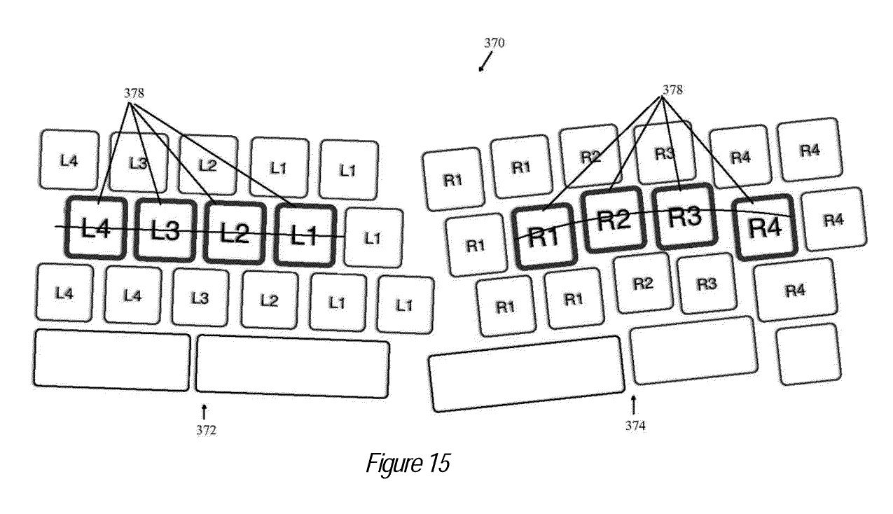

FIG. 15 is a schematic view representative of an exemplary virtual on-screen keyboard 370. The keyboard 370 is divided into two halves: a left half 372 and a right half 374 (as correlates to the left and right hands of the user). The two separate halves 372, 374 are not aligned with each other. The eight keys 378 that are typically rested on by the user are labeled in bold according to which finger is typically used for that key (e.g., L1 represents the index finger of the left hand, L4 represents the little finger of the left hand, and so on). All other nonhome-row keys are indicated by a label showing which finger is normally used to type that key using conventional touch-typing techniques. It should be noted, however, that there are many typing styles that do not use the finger placements as shown in FIG. 3B, and those labels are included herein for illustrative purposes only.

The left half of the keyboard 372 shows all the keys aligned in horizontal rows, as they would be on a traditional electromechanical keyboard. In one embodiment as shown on the right half 374, the home-row keys are dispersed along an arc to better fit the normal resting position of the user's four fingers. Nonhome-row keys are similarly dispersed in accordance with their relative location to the home-row resting keys. Further, in one embodiment, the size of each key may also vary in accordance with the statistical likelihood that the user will select that key (the higher the likelihood, the larger the key).

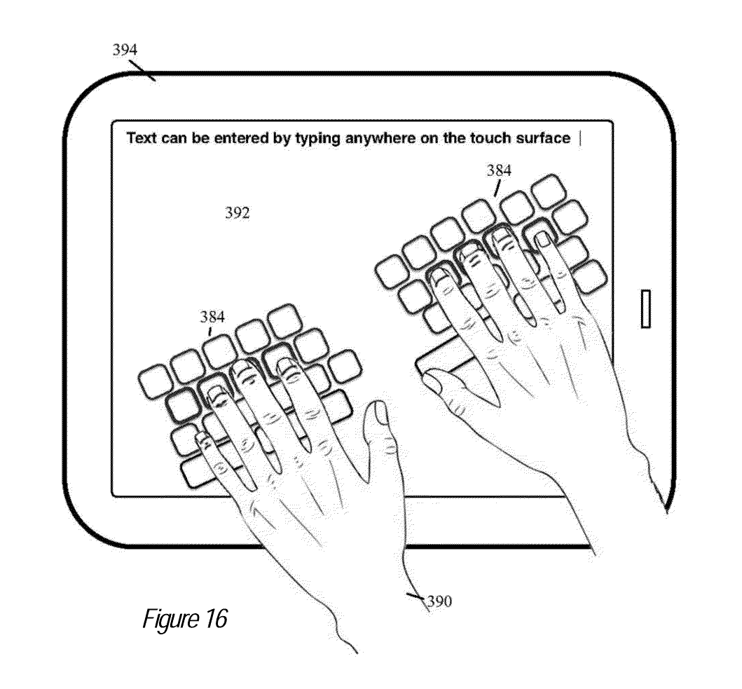

FIG. 16 is a schematic view representative of the virtual on-screen keyboard 384 that is oriented at an angle in accordance with an embodiment of the present invention. The user may rest their hands 390 on the touch-sensitive surface 392 of a typical handheld tablet computer 394 at any location and orientation that they wish. In this case, the hands are spread apart further than normal and oriented at an angle as referenced to the straight edges of the device 394. The user initiates an action indicating a “home-row definition event”, which, may include, but is not limited to, the following: resting all eight fingers for a short, user-definable period of time; double-tapping all eight fingers simultaneously on the surface 392 and then resting them on the surface 392; or pressing down all eight fingers simultaneously as they are resting on the surface 392. In another embodiment, not all eight fingers are required to initiate a home-row definition event. For example, if someone was missing their middle finger, a home-row definition event may be initiated by only three fingers on that hand. Here the user has rested their hands 290 at an angle on the tablet computer 394, thus causing a processor of the computer 294 to generate and display the virtual on-screen keyboard 384 at an angle.

The present invention builds on U.S. patent application Ser. No. 12/234,053 (Marsden) which allows the user to rest their fingers on a touchscreen and distinguishes between fingers resting and fingers typing by employing both touch and vibration sensors.

In the present invention, the user rests their fingers anywhere on the surface of the touchscreen and begins typing by tapping their finger on a virtual key as they would on a regular keyboard (assuming, for example, a qwerty keyboard layout). The system detects the time and location of this tap and assigns it as the first letter of the desired word. The user then taps on the next virtual key, the system notes the time and location as the second letter of the word, and so on.

As the user proceeds with typing the word, the system determines the relative location of each key selection with those that preceded it, and compares those values with a pre-stored database containing the relative key positions for common words. By so doing, the system allows the user to define the “size” of the onscreen keyboard to be anything on which they can reliably distinguish key selection locations.

Even for short words, the relative key locations quickly become unique.

In a further embodiment of the invention, the system detects which finger is used for a given key selection (which is especially useful for 10-finger touch typists). The approach is helpful in disambiguating between words that might have very similar relative letter locations (such as “put”, “pit”, and “pot”). Because each of the vowels u, i, and o are typically typed with a different finger, it is possible to discern which letter was intended—even if the relative change from the first letter “p” is the same.

The space key, or other word ending punctuation, determines the end of the word.

In one embodiment, most likely predicted words appear on the screen in a list next to the text insertion point or another convenient location. If the desired word appears in the list, the user may select it by simply tapping it. If the desired word is the default word in the list, the user may select it by tapping the return key on the onscreen keyboard.

The present invention may be combined with other disambiguation approaches commonly referred to as word prediction algorithms for even greater accuracy.

A simplified version of the algorithm performed by the CPU 110 is as follows:

Step 1: user enters the first letter of a word. System stores x₁ and y₁ for location L₁ of the first letter.

Step 2: user selects the next letter of a word. System stores x₂ and y₂ for location L₂ of the second letter.

Step 3: System determines Δx_{1,2} and Δy_{1,2} to find the change in x and y locations

Δx_{1,2}=x₁−x₂

Δy_{1,2}=y₁−y₂

Step 4: System determines the absolute distance between L₁ and L₂

d₁₂=√((x₁−x₂)²+(y₁−y₂)²))

Step 5: Normalize the change in x and y directions

ΔxN_{1,2}=Δx₁₂/d_{1,2}

ΔyN_{1,2}=Δy₁₂/d_{1,2}

Step 6: Compare the normalized change in direction between the first two letters with those stored in the word database. The difference is calculated as an error E (Ex₁₂, for example, is the difference between the calculated normalized change in x and the pre-stored change in x between the first two letters). Select candidate words within a tolerance level T (where T is a user-settable variable).

Ex₁₂=ABS(ΔxN_{1,2}−Δx_{1,2} (stored for word n in the database))

Ey₁₂=ABS(ΔyN_{1,2}−Δy_{1,2} (stored for word n in the database))

T=ΣExₙ+ΣEyₙ

Step 7: Repeat steps 2 through 6 for each letter of the word, until a word-ending character is detected (space, period, etc).

Step 8: Output the word that falls within the tolerance error level T. (If more than one word falls within the tolerance level, display them in a user selectable list, or output the word with the lowest tolerance error).

For additional accuracy, the segment length from letter to letter can be summed into a total distance for the entire word. This number can then be used to normalize the absolute distances between each letter and compared with the same in the word database.

So, d_{Total}=Σdistance between each letter=d_{1,2}+d_{2,3}+ . . . +d_{(n-1),n}

Thus the normalized distance between each letter is:

dN_{1,2}=d_{1,2}/d_{Total}

So, each word in the database would have at least the following data fields:

| Data field | Description |
|---|---|
| ΔxN_{1,2} | The normalized change in x-direction |
| | between the first and second letter of the |
| | word. |
| ΔyN_{1,2} | The normalized change in y-direction |
| | between the first and second letter of the |
| | word. |
| . . . | . . . |
| ΔxN_{n-1,n} | The normalized change in x-direction for |
| | the last two letters of the word. |
| ΔyN_{n-1,nN} | The normalized change in y-direction for |
| | the last two letters of the word. |
| dN_{1,2} | The normalized distance between the first |
| | and second letters of the word. |
| . . . | . . . |
| dN_{n-1,n} | The normalized distance between the last |
| | two letters of the word |
| d_{Total} | The sum of all the distances |

For 10-finger touch typists, each letter of the keyboard is assigned to a specific finger. The system can determine which finger was used to type a letter through the correlation of touch and vibration sensors. Thus, if a letter pattern is very similar for two or more words, the finger-assignment database can be invoked by the system to determine the most likely letter typed based on which finger was used.

For example, the words “in” and “on” have very similar letter travel signatures, making them difficult for the system to disambiguate. However, at least for a touch typist, the letter “i” is typically typed with the right middle finger, while the letter “o” is typically typed using the right ring finger. Thus even though the values stored in the word database are similar for both words, the system can still tell which word the user meant to type.

### Typing Styles

Studies have shown that roughly 30% of typists use nine or ten fingers (“touch typists”) and less than 5% use only two or three fingers. The remaining 65% are hybrid typists who use 4, 5, 6, 7, or 8 fingers. Models for each of these typing styles are stored in a database and the system constantly analyses the typing style of the user to determine what category of typist they are. Once identified, these models can be used to determine which finger is used for which key, and thus contributes to the disambiguation algorithms as described above.

There are many other mathematical operations that could be performed on the location data for each letter of a word that may further enhance the algorithm. What is described above is a simplified version intended for explanatory purposes, and the invention should not be considered to be restricted to only the algorithm described herein.

### “Hello” Example

As a simplified example, consider typing the word “hello” on the keyboard shown in FIG. 1. Consider the vertical lines as a course grid, along with each row of the keyboard. The user begins by typing the letter “h”, followed by a key that is 3.5 grid spaces to the left and one grid space up from h. The letter “l” follows “e” by the user selecting a key that is 6.5 grid spaces to the right and one grid space down, and so on. The database for the word “hello” would look like:

| Letter Pair | ΔX | ΔY |
|---|---|---|
| he | −3.5 | 1 |
| el | 6.5 | −1 |
| ll | 0 | 0 |
| lo | −0.5 | 1 |
| Total | 10.5 | 3 |
| Travel | | |

Even for a common 5-letter word such as hello, the travel pattern between keys is very unique. Very few words will have a similar pattern.

The database representation has been simplified for this example. In order to accommodate a variety of typing styles, the distance between letters wouldn't be fixed as shown in FIG. 1, and thus the need to normalize the travelled distances.

### User Typing Style Adaptation

As a user begins to type frequently, the system can begin to learn the user's typing style. For example, it can determine the approximate size of the onscreen keyboard and relative distances between keys specific to a certain user. In so doing, it can adapt by dynamically updating the word database to better match the user's typing style.

For example, if a user types the word hello, but instead of moving −3.5 grid spaces horizontally between the h and e keys, the user might only move −3 grid spaces. After the word is completed, the system would see that there are no other matches for the word within the tolerance levels, other than the word “hello”, and so it could adapt its model so that now the distance between h and e stored in the database becomes −3.

### Storage of User Settings

This dynamic learning of the user's typing style can be stored both locally and in the “cloud” over a network. In this way, the same user may move from device to device (or touchscreen to touchscreen) and once the system identifies who the user its, it will load the settings and word databases specific to that user.

### Dynamic Topical Dictionaries

The word database itself can also change according to user identity. For example, a doctor may frequently use medical terms when writing, that wouldn't normally exist in a common-words database. The user can manually “load” topical dictionaries as part of their text entry settings, and/or the system can automatically detect when certain words are used and dynamically load the relevant dictionaries.

For example, a user may type the word “King”, which is identified in the common word dictionary as a medium frequency-of-use word. But in short succession, the user also types “Queen”, “Pawn”, and “Rook”. The system discerns that these words, while relatively uncommon in the main database, are very common in the Chess topical dictionary. It therefore begins to consider words in the Chess word database (mixed with words from the main database) with a higher probability as a result.

Topical dictionaries can be stored in the cloud, and this dynamic adaptation to the user may happen at any location and on any device where the user is uniquely identified. Thus in a future that has fewer personal devices, but a more ubiquitous computing environment where interfaces to information are embedded into the physical world around us, an individual's typing settings can follow with them.

### Next-Next Word Prediction Using Conjunctions and Articles

A common strategy in word prediction is to store associations between words, called “next-word prediction”. For example, if your name were John Smith, then Smith would be a very common next-word to follow John. These relationships can be stored in a reasonably sized database and used to help disambiguate typing as described herein.

However, next-word prediction fails with certain very common words. For example, consider the word “the” (most commonly used word in the English language). Let's say a user typed “kick the”. Suddenly, nearly every noun, adverb, and adjective become potential next-word candidates for the word “the”, losing all the context of “kick”. In this case, the next-word prediction provides virtually no help in disambiguating typing.

If the system were to store next-next-word relationships for all the words in the database, it would quickly become unwieldy; simply too many word relationships would exist (the majority of which would never occur). Instead, we recognize that there are a relatively few number of words that have a large number of likely next-words associated with them. These words are labeled as conjunctions and articles in English. The table below shows common conjunctions and articles.

| Part of Speech | Example words |
|---|---|
| Conjunctions | And, but, for, or, nor, yet, and so |
| Articles | A, an, the |

Next-Next-word relationships are stored in the database for only these words, by joining them with the word that preceded them. For example, “kick the” would become a new word in the database stored as “kickthe”. Now the new word entity kickthe has a relatively few common next words, such as ball, bucket, and habit. Thus the context of “kick” is preserved.

This type of next-next-word prediction can be very helpful in disambiguating typing according to the method described in the present invention.

There are many other mathematical operations that could be performed on the location data for each letter of a word that may further enhance the algorithm. What is described above is a simplified version intended for explanatory purposes, and the invention should not be considered to be restricted to only the algorithm described herein.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
inputting a sequence of key selections on a virtual keyboard associated with an intended word;
identifying the relative change in distance between each letter of the intended word; comparing the relative changes in distance between each letter of the intended word with the relative changes in distance between each letter of words stored in a database; and
identifying the word in the database that most closely matches the pattern input by the user.

2. Claim 1 where the user input is determined by a combination of touch and vibration sensors.

3. Claim 1 where a word-ending character is selected in the same manner as all other characters on the virtual keyboard.

4. Claim 1 where Cartesian coordinates are used to determine the relative changes in distance between each letter of the intended word.
